(19) United States
(12) Patent Application Publication
(10) Pub. No.: US 2026/0295808 A1
(43) Pub. Date: Oct. 1, 2026

(54) Docking Accessories with Intermediate States for Mobile Robots

(71) Applicant: Skild-Fetch LLC, Pittsburgh, PA (US)

(72) Inventors: Cory D. Lent, Campbell, CA (US); Charles Pitzer, San Jose, CA (US); Vincent C. Cheung, San Jose, CA (US); Matthew Wicks, St. Charles, MO (US)

(73) Assignee: Skild-Fetch LLC, Pittsburgh, PA (US)

(21) Appl. No.: 19/096,245

(22) Filed: Mar. 31, 2025

(51) Int. Cl. B25J 5/00; B25J 9/00; B25J 9/16; B25J 13/08

(52) U.S. Cl. CPC B25J 5/007; B25J 9/0009; B25J 9/161; B25J 13/08

(57) ABSTRACT

A mobile robot includes: a chassis; a locomotive assembly secured to the chassis; a coupling device disposed on the chassis, the coupling device configured to engage with a track of a target object; and a processor configured to: control the locomotive assembly to position the coupling device relative to the track select between (i) an intermediate state, and (ii) a docked state; in response to selecting the intermediate state, control the coupling device to permit motion of the coupling device along a length of the track, and constrain motion of the coupling device orthogonal to the track; and in response to selecting the docked state, control the coupling device to engage the track and constrain motion of the coupling device along the length of the track.

### BACKGROUND

Autonomous or semi-autonomous mobile robots can be deployed in facilities such as warehouses, manufacturing facilities, healthcare facilities, or the like, e.g., to move items within the relevant facility. The items may be supported on carts or the like, and the robots may be configured to engage with (or dock), and disengage from, the carts to move the carts about the facility. The positional accuracy involved in docking with a cart, however, may be challenging to implement, and each docking operation may therefore involve multiple attempts to dock before succeeding.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of item-handing mobile robots deployed in a facility.

FIG. 2A is a diagram of a mobile robot of FIG. 1.

FIG. 2B is a diagram of certain internal components of the mobile robot of FIG. 2A.

FIG. 3A is a diagram of the mobile robot of FIG. 2A in a first position relative to a cart of FIG. 1.

FIG. 3B is a diagram of the mobile robot of FIG. 2A in a second position relative to a cart of FIG. 1.

FIG. 4A is a diagram of a docking accessory for the mobile robot of FIG. 2A.

FIG. 4B is a diagram of the docking accessory of FIG. 3A when mounted on the mobile robot.

FIG. 5A is a diagram of a dock on the cart of FIG. 1.

FIG. 5B is a diagram of the coupling device of FIG. 4A in a docked state.

FIG. 5C is a diagram of the coupling device of FIG. 4A in an intermediate state.

FIG. 5D is a diagram of the coupling device of FIG. 4A in an undocked state.

FIG. 6 is a flowchart of a method for controlling a docking accessory.

FIG. 7A is a diagram of another example coupling device in a docked state.

FIG. 7B is a diagram of the coupling device of FIG. 7A in an intermediate state.

FIG. 7C is a diagram of the coupling device of FIG. 7A in an undocked state.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a mobile robot, comprising: a chassis; a locomotive assembly secured to the chassis; a coupling device disposed on the chassis, the coupling device configured to engage with a track of a target object; and a processor configured to: control the locomotive assembly to position the coupling device relative to the track select between (i) an intermediate state, and (ii) a docked state; in response to selecting the intermediate state, control the coupling device to permit motion of the coupling device along a length of the track, and constrain motion of the coupling device orthogonal to the track; and in response to selecting the docked state, control the coupling device to engage the track and constrain motion of the coupling device along the length of the track.

Additional examples disclosed herein are directed to a method, comprising: selecting, at a processor of a mobile robot having a coupling device configured to engage a track of a target object, between (i) an intermediate state, and (ii) a docked state; in response to selecting the intermediate state, controlling the coupling device relative to the track to permit motion of the coupling device along a length of the track, and constrain motion of the coupling device orthogonal to the track; and in response to selecting the docked state, controlling the coupling device to engage the track and constrain motion of the coupling device along the length of the track.

Further examples disclosed herein are directed to a docking accessory for a mobile robot, the docking accessory comprising: a base configured for connection with a chassis of a mobile robot; a coupling device disposed on the base, the coupling device movable between (i) an engaged position to engage the coupling device with a track of a target object and constrain motion of the coupling device along a length of the track, and (ii) a disengaged position to permit motion of the coupling device along the length of the track, and constrain motion of the coupling device orthogonal to the track; and a communications interface to communicatively connect the coupling device with a processor and receive control instructions therefrom.

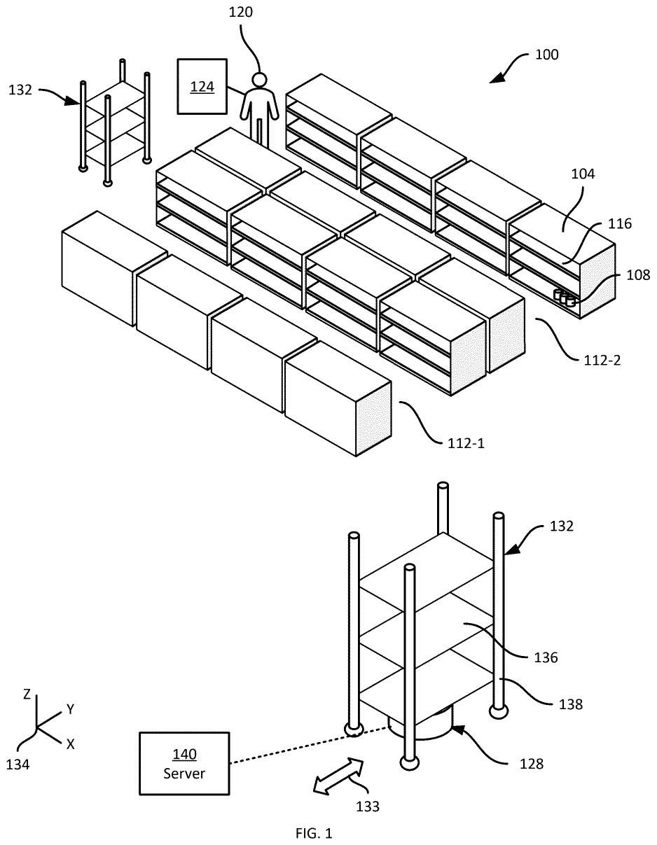

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112-1 and 112-2 (collectively referred to as the aisles 112, and generically referred to as an aisle 112; similar nomenclature may be used herein for other components with hyphenated reference numbers). In the examples shown in FIG. 1, the support structures 104 include support surfaces 116 supporting the items 108. The support structures 104 can also include pegboards, bins, tables, or the like, in other examples. In some examples, the support structures 104 can include portions of a floor of the facility 100, in addition to or instead of distinct structures disposed on the floor, such as the shelf modules shown in FIG. 1.

In other examples, the facility 100 can include fewer aisles 112 than shown, or more aisles 112 than shown in FIG. 1. The aisles 112, in the illustrated example, are formed by sets of support structures 104 (four on each side, although it will be understood that the aisles 112 may have a variety of lengths defined by varying numbers of support structures 104). The facility 100 can also have a wide variety of other aisle layouts, however. As will be apparent, each aisle 112 is a space open at opposing ends, and bounded on either side by one or more support structures 104. The aisles 112 can be travelled by humans, certain vehicles, and the like. In still further examples, the facility 100 need not include aisles 112, and can instead include assembly lines, or the like.

The items 108 may be handled according to a wide variety of processes, depending on the nature of the facility. In the examples discussed below, the facility 100 is a fulfillment facility or the like, and the items 108 disposed on the support structures 104 can be retrieved for shipping from the facility 100 to fulfill incoming orders each indicating identifiers of certain items. The retrieval of an item 108 from a support structure 104 is also referred to as a pick operation. Picks can be performed in the facility 100 by a picker 120, such as a human worker. Although one picker 120 is shown in FIG. 1, it will be understood that various numbers of pickers can be deployed in the facility 100, e.g., depending on the size of the facility 100, the rate at which orders are received for fulfillment, and the like. Each picker 120 can operate a client computing device 124, such as a tablet computer, a smartphone, a wearable computer, or the like. The client device 124 enables the presentation of information to the picker 120, the capture of information from the picker 120, e.g., indicating completion of a pick task, or the like.

Order fulfillment in the facility 100 can be assisted by mobile robots, of which an example robot 128 is shown in FIG. 1. Additional robots 128 can be deployed in the facility 100, for example based on the size and/or layout of the facility 100. As will be discussed below, the facility 100 may contain a greater number of robots 128 than pickers 120 in some embodiments. In other embodiments, a number of robots 128 deployed in the facility 100 may be smaller than a number of pickers 120 in the facility 100.

To perform an order fulfillment task, or a portion thereof, the picker 120 can retrieve one or more items 108 from a support structure 104, and place the items 108 on a movable support, such as a wheeled cart 132 having one or more shelves or other support surfaces 136 supported by legs 138. Two example carts 132 are shown in FIG. 1, but it will be understood that the number of carts 132 deployed in the facility 100 may vary according to the size of the facility and/or other operational considerations. Further, the number of carts 132 deployed in the facility 100 need not match either of the number of robots 128, or the number of pickers 120.

The items 108 involved in fulfilling an order may be on support structures 104 at various locations in the facility. A given cart 132 may be moved about the facility 100 to collect the relevant items 108 for the order, e.g., before being moved to a pack-out area or the like. Moving of the cart 132 to various locations in the facility 100 can be performed by the robot 128. The robot 128 can navigate through the facility 100 while tracking its pose (e.g., location and orientation) relative to a coordinate system 134 previously established in the facility 100. The robot 128 can dock with a cart 132 and therefore move the cart about the facility during such navigation. The robot 128 can receive target locations to navigate to, e.g., to collect a cart 132, and to move that cart 132 to a sequence of pick locations to receive items 108 from the support structures 104 (e.g., placed on the cart 132 by the picker 120). The target locations, and/or other control data, can be received at the robot 128 from a server 140 or other suitable computing device via one or more communication networks deployed within the facility 100. In other examples, the robot 128 can also be configured to dock with a target object other than a cart 132. For example, the robot 128 can be configured to transport equipment between locations in the facility 100 by docking with the equipment and navigating to such locations towing the docked equipment.

When the robot 128 approaches a cart 132, the robot 128 can initiate a docking procedure that involves positioning the robot in a predetermined pose relative to the cart 132 (e.g., dependent on the direction in which the robot 128 is intended to move the cart 132), and activating a docking accessory to mechanically couple the robot 128 to the cart 132. Mitigating unexpected movements of the cart 132 during transit involves limiting or substantially eliminating movement of the cart 132 relative to the robot 128 when docked. The docking accessory may therefore have tight tolerances, and the robot 128 may be required to position itself relative to the cart 132 with a high degree of accuracy. Errors in localization by the robot 128 may lead to a failed docking attempt, followed by an attempt to correct the position of the robot 128 relative to the cart 132 and a repeated attempt to dock with the cart 132. Each such attempt consumes time, reducing the availability of the robot 128 and the cart 132 for order fulfillment or other suitable tasks.

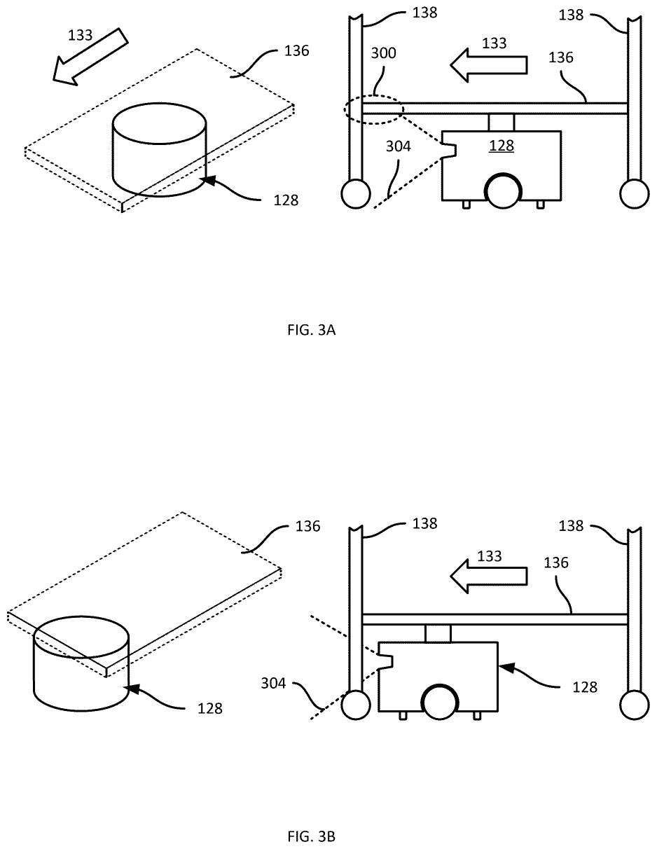

In some examples, the robot 128 can be configured to dock with the cart 132 at more than one predetermined pose relative to the cart 132. For example, some use cases may involve moving the cart 132 forwards or backwards, as indicated by the arrow 133 in FIG. 1. Other use cases may involve moving the cart orthogonally to the arrow 133, e.g., with a longer side of the cart 132 leading rather than a shorter side. As will be discussed below in connection with FIGS. 3A and 3B, certain poses of the robot 128 relative to the cart 132 may be more suitable for certain directions of travel. Changing the pose of the robot 128 after docking in prior systems, however, may involve disengaging from the cart 132, which may lead to further failed docking attempts. Docking accessories for the robot 128 are discussed below that reduce the likelihood of such failed docking attempts by providing an intermediate docking state that permits reorientation of the robot 128 relative to the cart 132 without fully disengaging from the cart 132.

The robot 128, as discussed below, can include a docking accessory that provides a robust mechanical connection with the cart 132, e.g., limiting or eliminating movement of the cart 132 relative to the robot 128, while also increasing the likelihood of successful docking on any given docking attempt. In other words, the docking accessories described herein may permit successful docking by the robot 128 in the presence of localization errors sufficient to cause docking failures in certain other docking accessories. Further, the docking accessory as described herein permits the robot 128 to remain coupled with the cart 132 in an intermediate state, in which motion of the cart 132 relative to the robot 128 is constrained in one or more dimensions, and permitted in one or more other dimensions. The provision of multiple states, e.g., an intermediate state and a docked state, may facilitate changes in pose between the robot 128 and the cart 132 while mitigating or avoiding docking failures that might result from fully disengaging the robot 128 from the cart 132 to reposition to another predetermined pose.

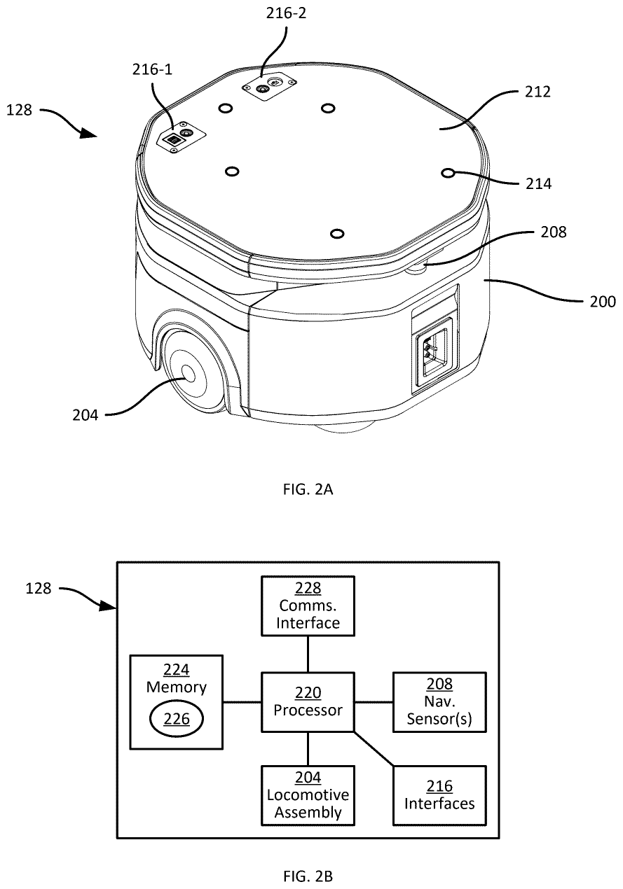

Before discussing the above-mentioned docking accessories in greater detail, certain components of the robot 128 are discussed with reference to FIGS. 2A and 2B. As shown in FIG. 2A, the robot 128 includes a chassis 200 supporting various other components of the robot 128. In particular, the chassis 200 supports a locomotive assembly 204, such as one or more electric motors, e.g., powered by an onboard battery or other suitable power source, driving a set of wheels, tracks, or the like. The locomotive assembly 204 can include one or more sensors such as a wheel odometer, an inertial measurement unit (IMU), and the like. The chassis 200 also supports one or more navigational sensors 208, such as one or more cameras and/or depth sensors (e.g., lidars, depth cameras, time-of-flight cameras, or the like). The sensor(s) 208 can be configured to capture image and/or depth data depicting at least a portion of the physical environment of the robot 128. Data captured by the sensor(s) 208 can by used by processing hardware of the robot 128 for navigational purposes, e.g., path planning, obstacle avoidance, and the like.

The chassis 200 can also define a mounting surface 212, e.g., on an upper wall of the chassis 200, for removably receiving one or more accessories. The mounting surface 212 can removably receive a docking accessory, as described below. The docking accessory can be affixed to the chassis 200 via fasteners such as bolts or the like, removably received in openings 214 on the mounting surface 212. The mounting surface 212 can also include one or more interface assemblies 216-1 and 216-2. The assembly 216-1 includes, in this example, a communications interface such as a Universal Serial Bus (USB) port, and a power delivery port. The assembly 216-2 includes, in this example, a communications interface such as an Ethernet port (e.g., an RJ-45 port), and a further power delivery port. A variety of other interface assembly configurations can also be implemented, e.g., incorporating two or more communications interfaces in one assembly 216 rather than divided between the assemblies 216-1, 216-2 as shown in FIG. 2.

FIG. 2B is a block diagram of certain components of the robot 128, including certain internal components not shown in FIG. 2A. In particular, the robot 128 includes a processor 220, e.g., one or more central processing units (CPUs), graphics processing units (GPUs), or dedicated hardware controllers such as application-specific integrated circuits (ASICs). The processor 220 is communicatively coupled with a non-transitory computer readable medium such as a memory 224, e.g., a suitable combination of volatile and non-volatile memory elements. The memory 224 stores various data used for autonomous or semi-autonomous navigation, including computer-readable instructions executable by the processor 220 to implement navigational and other task execution functions. The memory 224 can store, for example, computer-readable instructions defining a navigational application 226 whose execution by the processor 220 configures the robot 128 to implement docking functionality via control of the docking accessories described herein.

The processor 220 is also coupled with a communications interface 228, such as a wireless transceiver enabling the robot 128 to communicate with other computing devices, such as the server 140, client device 124, and other robots 128. The processor 220 can also be communicatively connected with the interface assemblies 216 mentioned above, e.g., to control accessories such as a docking accessory affixed to the chassis 200, and in some implementations, to receive sensor data from such accessories.

Turning to FIG. 3A, a simplified representation of a lower support surface 136 (e.g., support surfaces 136 shown closest to the ground in FIG. 1) with the robot 128 shown substantially centered under the support surface 136. In this example, when the robot travels in a direction 133 (corresponding to the direction of travel shown in FIG. 1), the dimensions of the support surface 136 are such that a portion 300 of the support surface 136 occludes a portion of a field of view 304 of the sensors 208 (e.g., in a horizontal direction). Additionally, the legs 138 of the cart 132 may also occlude a portion of a field of view 304 of the sensors 208 (e.g., in vertical horizontal direction). The support surface 136 and/or legs 138 may, as a result of such occlusion, impede the ability of the robot 128 to detect obstacles such as overhangs or the like. Those of ordinary skill in the art will understand that other components and areas of the cart 132 may also occlude one or more portions of the field of view 304 of the sensors 208, depending on the particular arrangement of the robot 128 relative to the cart 132.

FIG. 3B illustrates a scenario in which the robot 128, to travel in the direction 133, is positioned near one end of the cart 132, rather than near the center of the cart 132. When the robot 128 is in the position shown in FIG. 3B, occlusion of the field of view 304 by the support surface 136 is reduced or eliminated. As will be understood by those skilled in the art, different positions of the robot 128 relative to the support surface 136 may therefore be practical at different times. For example, during orthogonal movement, perpendicular to the direction 133 in the x-y plane (see FIG. 1), centering the robot 128 under the cart 132 may be desirable. During forwards and backwards movement in the direction 133, placing the robot 128 at or near the leading end of the cart 132 may be desirable. As a result, the optimal position of the robot 128 relative to the cart 132 may change during operation, for example to reverse the direction of travel of the cart 132. The docking accessories described below, along with control functionality implemented by the processor 220 via execution of the application 226, permit the robot 128 to engage with the cart 132 with imperfect localization, and also permit the robot 128 to reposition itself relative to the cart 132 without fully disengaging, thus reducing or eliminating the need to relocalize, and mitigating further failed docking attempts.

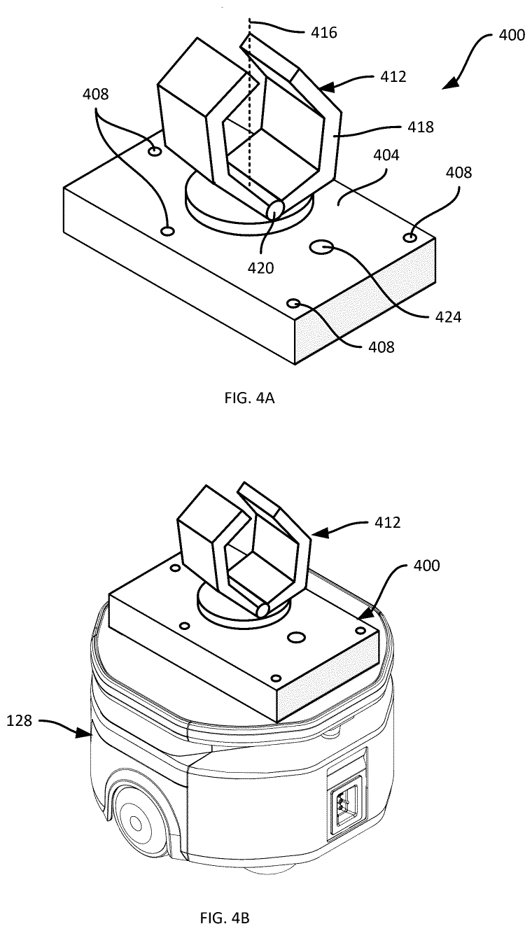

Turning to FIG. 4A, a docking accessory 400 is shown in isolation and FIG. 4B illustrates the docking accessory 400 when attached to the chassis 200 of the robot 128. The docking accessory 400 includes a base 404 configured to engage with the mounting surface 212 of the robot 128, as discussed above in connection with FIG. 2A, e.g., by way of bolts or other suitable fasteners extending through apertures 408 defined through the base 404 into the openings 214 of the mounting surface 212. Various other mechanisms for fastening the docking accessory 400 to the chassis 200 can also be employed, such as snap-fit features on the mounting surface and complementary latching features on the base 404. In other examples, the docking accessory 400 can be non-removably affixed to the chassis 200, e.g., as an integral component of the chassis 200.

The accessory 400 also includes a coupling device 412 disposed on the base 404. The coupling device 412 can be rotatably mounted on the base 404, e.g., about an axis 416, enabling rotation of the robot 128 relative to the cart 132 while docked. The coupling device 412 can rotate freely on the base 404 in some examples. In other examples, the coupling device 412 can be rotated relative to the base via a rotary solenoid or the like, permitting the processor 220 to control the rotation of the coupling device 412 and/or sense the angular position of the coupling device 412 about the axis 416. The base 404 can also include a positional sensor, e.g., in addition to or instead of the above-mentioned solenoid, in some examples. In some examples, where the robot 128 can actively rotate the coupling device 412, e.g., via a rotary solenoid or the like, the robot 128 can enable or disable such active rotation. In other words, the processor 220 can select between a mode in which the rotation of the coupling device 412 is constrained (e.g., fixed, or actively rotated), and a mode in which the coupling device 412 is permitted to rotate freely, e.g., according to movement of the cart 132.

The coupling device 412, in this example, includes a claw 418 movable between a closed position to grasp a track or rail extending from a target object, such as the cart 132, and an open position to disengage from the rail. In other examples, the coupling device 412 can have various other form factors, as will be discussed further below. The opposing members of the claw can articulate about a pivot 420.

The docking accessory 400 can also include a sensor 424, e.g., disposed on the base 404. In other examples, the sensor 424 can be integrated into the claw 418. The sensor 424 can be configured to detect a feature of a target object such as a cart 132. The sensor 424 is communicatively connected (e.g., via signal leads and an interface complementary to an interface 216 of the robot 128) with the robot 128. The processor 220 of the robot 128 can therefore obtain sensor data from the sensor 424 and determine whether a predetermined feature of the target object is proximal to the sensor 424. For example, the cart 132 or a component thereof can include a magnet located at or near a target docking position for the coupling device 412, such that the sensor 324, e.g., a Hall effect sensor, detects the magnet when the coupling device 412 is in position for docking with the cart 132. The processor 220 can, for example, activate the coupling device 412 to dock with the cart 132 in response to such detection. In other examples, the sensor 424 can include an image sensor, a photodiode, or the like, configured to detect a visual feature of the cart 132 such as a barcode, fiducial marker, or the like, instead of or in addition to the magnet mentioned above.

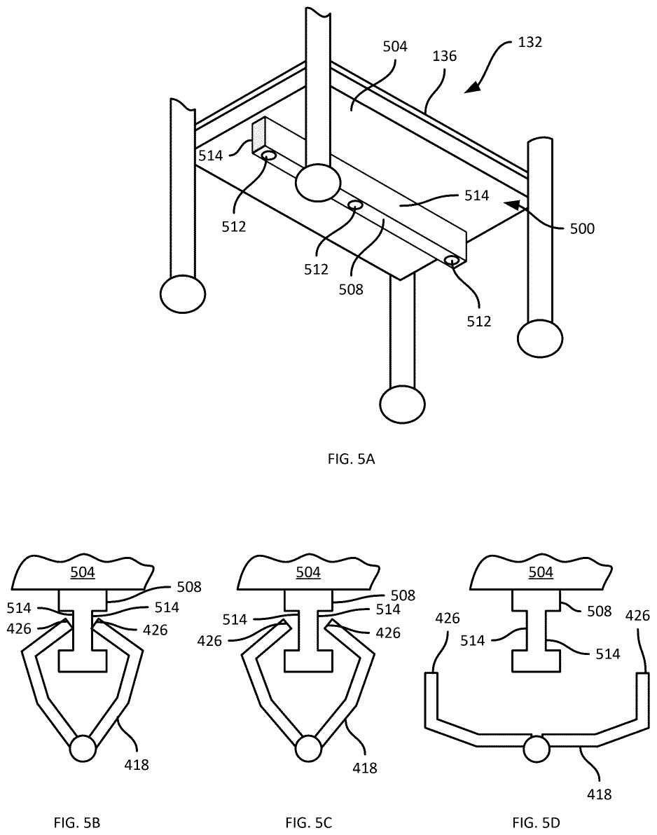

Turning to FIG. 5A, a lower portion of the cart 132 is shown from below. In addition to a bottom one of the support surfaces 136 (that is, the support surface 136 closest to the plane on which the cart 132 is configured to travel), the cart 132 includes a dock 500. The dock 500 can include a plate 504 affixed to an underside of the lower support surface 136. The plate 504 can be integrally formed with the lower support surface 136 in some examples. In other examples, the plate 504 is removably attached to the lower support surface 136, e.g., via fasteners such as bolts extending into a complementary plate above the lower support surface 136, zip ties, or the like. A cart 132 can, in other words, be retrofitted with a plate 504 for use with a robot 128 having the docking accessory 400. For example, a docking kit may include one or more docking accessories 400, and one or more plates 504 as described herein.

The plate 504 can extend over substantially the entire area of the support surface 136, as in the illustrated example. In other examples, however, the plate need not extend over the entire area of the support surface 136. The plate 504 includes a track 508 extending, in this example, along at least a portion of a length of the cart 132. The track 508 is provided as a rail extending outwards (e.g., downwards) from the plate 504. The rail can have a rectangular profile as shown in FIG. 5A, but can also have a variety of other profiles in other examples, such as an I-shaped profile as discussed below in connection with FIGS. 5B, 5C, and 5D.

The track 508 can also, in some embodiments, be recessed within the plate 504 rather than extending outwards from the plate 504. The track 508 provides surfaces with which the coupling device 412, e.g., the claw 418 in this example, can engage to constrain the motion of the robot 128 and the cart 132 relative to one another. The track 508 can also include one or more localization features 512, such as magnets, fiducial markers, barcodes or the like, detectable by the sensor 424.

FIGS. 5B-5D illustrate the track 508 and the claw 418, with the coupling device 412 in each of the operational states noted above. In FIG. 5B, the claw 418 is shown in a closed position, corresponding to an engaged, or docked, state of the coupling device 412. In this state, the claw 418 grasps opposing sides 514 of the track 508, constraining motion of the cart 132 relative to the robot 128 in both the longitudinal and orthogonal directions. In FIG. 5C, the claw 418 is shown in an intermediate position between open and closed, corresponding to an intermediate state of the coupling device 412. In the intermediate state, longitudinal movement between the cart 132 and the robot 128 (that is, movement parallel to the track 508) is permitted, while orthogonal movement is constrained. As will be apparent from FIG. 5C, some orthogonal movement may be permitted, but the movement permitted in the orthogonal direction (before one side of the claw 418 contacts the track 508 and prevents further orthogonal movement) is sufficiently small to prevent the robot from disengaging from the track 508. That is, when the coupling device 412 is in the intermediate state, the robot 128 is permitted to move along the track 508, but is constrained from disengaging entirely from the track 508. In FIG. 5D, the claw 418 is in an open position, corresponding to a disengaged, or undocked, state of the coupling device 412. When the claw 418 is in the open position, motion of the robot 128 relative to the cart 132 is substantially unconstrained. As those of ordinary skill and the art will understand, the claw 418 is configured to engage the track 508, such that the geometries of the claw 418 and the track 508 cooperate to prevent rotational movement of the claw 418 relative to the track 508 when the claw 418 is in the closed position. For example, as shown in FIGS. 5A-D, the claw 418 can include planar (e.g., flat) leading edges 426 configured to engage the planar interior sides 514 of the track 508. The claw 418 and/or the track 508 can also comprise materials and/or surface treatments selected to increase frictional engagement therebetween, thereby constraining longitudinal (e.g., sliding) movement between the claw 418 and the track 508. For example, a high friction coating, such as, but not limited to, rubber can be applied to one or more portions of the rail 508 (e.g., sides 514), the claw 418 (e.g., leading edges 426), or both. According to another example, a surface treatment, such as, but not limited to, knurling can be applied to one or more portions of the rail 508 (e.g., sides 514), the claw 418 (e.g., leading edges 426), or both. Of course, other configurations, materials, and/or surface treatments, which cooperate to prevent rotational and/or longitudinal movement of the claw 418 relative to the track 508, can be utilized without departing from the spirit and scope of the present disclosure.

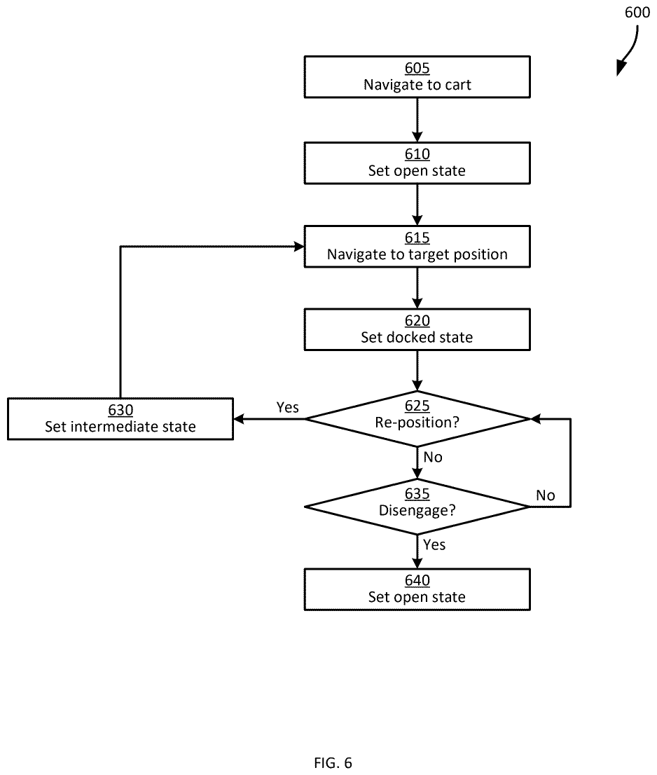

Turning to FIG. 6, a method 600 of engaging with a target object such as the cart 132 is illustrated. The method 600 is described below in conjunction with its performance by the processor 220 of the robot 128, e.g., via execution of the application 226 by the processor 220, and/or by equivalent dedicated hardware elements as noted earlier.

At block 605, the robot 128 is configured to navigate to a target object, such as the cart 132. Block 605 may be initiated, for example, in response to receipt of an instruction at the robot 128 from the server 140 to travel to a certain location (e.g., defined in the coordinate system 134) and dock with a cart 132 at that location. The navigational operations implemented by the robot 128, e.g., using data captured by the sensors 208, to travel to the relevant location, are beyond the scope of this discussion. A wide variety of mechanisms for performing those operations will occur to those skilled in the art. The robot 128 is configured, via block 605, to position itself adjacent to (e.g., underneath, in the examples shown herein) the target cart 132 to prepare for docking.

When the robot 128 has positioned itself adjacent to the cart 132, the processor 220 is configured to select between the intermediate state, the docked state, and the disengaged state, and to control the coupling device 412 according to the selected state. The processor 220 can alternate between the intermediate and docked states more than once in some examples, e.g., to reposition the robot 128 relative to the cart 132 without disengaging from the cart 132.

For example, at block 610 the processor 220 can be configured to set the coupling device 412 to the open state. In other words, the processor 220 can control the coupling device 412 to permit motion of the coupling device 412 (and thus of the robot 128) along the track 508, as well as orthogonal to the track 508.

At block 615, the processor 220 can control the locomotive assembly 204, e.g., with input from the sensors 208, to navigate to a target position along the track 508. For example, the processor 220 can be configured to select between predetermined target positions (e.g., corresponding to the positions of the localization features 512 shown in FIG. 5A) based on a planned direction of travel once the robot 128 is docked with the cart 132. At block 620, upon reaching the target position, which may be confirmed by detection of a localization feature 512 by the sensor 424, the processor 220 can be configured to select the docked state, controlling the coupling device 412 to constrain motion of the coupling device 412 along the track 508, as well as orthogonally to the track 508. In other words, the processor 220 can be configured to set the claw 418 to the closed position shown in FIG. 5B.

At block 625, the processor 220 can be configured to determine whether to re-position the robot 128 relative to the cart 132, e.g., based on navigational requirements to fulfill a cart-transport task assigned to the robot 128. When the determination at block 625 is affirmative, the processor 220 can proceed to block 630, selecting the intermediate state and thus permitting motion of the coupling device 412 along the track 508, while constraining motion orthogonal to the track 508. In other words, switching from the docked state to the intermediate state permits the robot to move relative to the cart 132, without entirely disengaging with the cart 132, which could necessitate another docking attempt. The robot 128 can then return to block 615, e.g., to navigate to a different position along the track 508. As will be apparent, the coupling device 412 may also mitigate failed repositioning/docking attempts due to minor localization errors, as the claw 418 can engage with the track 508 and move the robot 128 or the cart 132 into alignment with one another in the event of such localization errors.

When the determination at block 625 is negative, the processor 220 can maintain the docked state, and determine at block 635 whether to disengage from the cart 132 or other target object (e.g., if an assigned transport task corresponding to the cart 132 has been completed). When the determination at block 635 is negative, the processor 220 can return to block 625. When the determination at block 635 is affirmative, the processor 220 can set the coupling device 412 to the open, or disengaged, state at block 640, following which the robot 128 can move away from the cart 132.

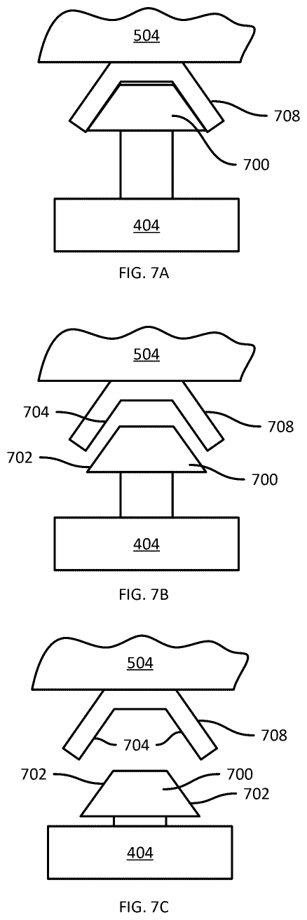

Referring to FIGS. 7A, 7B, and 7C, another coupling device is shown, in the form of a plunger 700. A track 708, in this example, can be implemented as a channel extending along at least a portion of the plate 504. The plunger 700 can be configured to frictionally engage with the channel in an extended state, shown in FIG. 7A, to constrain motion of the coupling device 412 both orthogonally to the track 708 and along the track 708. In the intermediate state, shown in FIG. 7B, the plunger 700 can be partially retracted such that motion of the coupling device 412 is constrained orthogonally to the track 708, and permitted along the track 708. That is, the plunger 700 in the intermediate state still extends partially into the channel. According to some embodiments of the present disclosure, the plunger 700 can comprise a trapezoidal cross-sectional area, as shown in FIGS. 7A-C, and can be formed as a conical frustrum. According to other embodiments, the plunger 700 can comprise a trapezoidal cross-sectional area, but be can be formed as a trapezoidal prism, such that lateral faces 702 of the plunger 700 extend parallel with respective interior lateral faces 704 of the channel, thereby constraining rotational movement of the plunger 700 relative to the track 708, for example, when the plunger 700 is in the extended state, shown in FIG. 7A, and/or the intermediate state, shown in FIG. 7B. In a disengaged or retracted state, shown in FIG. 7C, the plunger 700 is fully withdrawn from the channel, such that motion of the coupling device 412 is unconstrained relative to the cart 132.

According to additional aspects of the present disclosure, the coupling device 412 can include various other features. For example, the track 508 and/or the track 708 can include apertures at the predetermined docking positions, and the coupling device can include one or more pins configured to extend into the apertures in the docked state, to further constrain movement of the coupling device 412 along the tracks 508 and/or 708. For example, the leading edges 426 of the claw 418 can include pins or other suitable members, configured to extend from the leading edges 426 into apertures in the sides 514 of the track 508. The plunger 700 can include pins or other suitable members configured to extend from the lateral surfaces 702 or from an upper surface of the plunger 700 into apertures defined in a corresponding surface of the track 708.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A mobile robot, comprising:
a chassis;
a locomotive assembly secured to the chassis;
a coupling device disposed on the chassis, the coupling device configured to engage with a track of a target object; and
a processor configured to:
control the locomotive assembly to position the coupling device relative to the track
select between (i) an intermediate state, and (ii) a docked state;
in response to selecting the intermediate state, control the coupling device to permit motion of the coupling device along a length of the track, and constrain motion of the coupling device orthogonal to the track; and
in response to selecting the docked state, control the coupling device to engage the track and constrain motion of the coupling device along the length of the track.

2. The mobile robot of claim 1, wherein the coupling device includes a claw movable between (i) a closed position to grasp a rail extending from the target object to define the track, and (ii) an open position to disengage from the rail.

3. The mobile robot of claim 2, wherein the processor is configured to:
position the claw between the open and closed positions in the intermediate state; and
position the claw in the closed position in the docked state.

4. The mobile robot of claim 1, wherein the coupling device includes a plunger movable between (i) an extended position to frictionally engage with a channel of the target object defining the track, and (ii) a retracted position to disengage from the channel.

5. The mobile robot of claim 4, wherein the processor is configured to:
position the plunger between the extended and retracted positions in the intermediate state; and
position the plunger in the extended position in the docked state.

6. The mobile robot of claim 1, wherein the processor is further configured to:
in response to selecting the intermediate state, control the locomotive assembly to move the chassis along the length of the track;
determine when the chassis has reached a target position along the length of the track; and
select the docked state in response to the determination.

7. The mobile robot of claim 6, further comprising:
a sensor configured to detect a feature of the track;
wherein the processor is configured to determine when the chassis has reached the target position by determining that the sensor has detected the feature of the track.

8. The mobile robot of claim 7, wherein the sensor comprises at least one of:
a Hall effect sensor configured to detect a magnet on the track, or
an optical sensor configured to detect a machine-readable indicium on the track.

9. The mobile robot of claim 8, wherein the machine-readable indicium comprises at least one of:
a barcode, or
a fiducial marker.

10. The mobile robot of claim 1, wherein the coupling device is rotatably mounted on the chassis.

11. The mobile robot of claim 10, further comprising:
a positional sensor configured to monitor an orientation of the coupling device relative to the chassis.

12. The mobile robot of claim 10, wherein the coupling device is controllable by the processor to selectively permit and constrain rotational movement of the coupling device relative to the chassis.

13. A method, comprising:
selecting, at a processor of a mobile robot having a coupling device configured to engage a track of a target object, between (i) an intermediate state, and (ii) a docked state;
in response to selecting the intermediate state, controlling the coupling device relative to the track to permit motion of the coupling device along a length of the track, and constrain motion of the coupling device orthogonal to the track; and
in response to selecting the docked state, controlling the coupling device to engage the track and constrain motion of the coupling device along the length of the track.

14. The method of claim 13, wherein the coupling device is movable between an engaged position and a disengaged position, the method further comprising:
in the intermediate state, positioning the coupling device between the engaged and disengaged positions; and
in the docked state, positioning the coupling device in the engaged position.

15. The method of claim 13, further comprising:
in response to selecting the intermediate state, controlling a locomotive assembly of the mobile robot to move a chassis of the mobile robot along the length of the track;
determining when the chassis has reached a target position along the length of the track; and
selecting the docked state in response to the determination.

16. The method of claim 14, wherein determining when the chassis has reached the target position comprises: determining that a sensor of the mobile robot has detected a feature of the track.

17. A docking accessory for a mobile robot, the docking accessory comprising:
a base configured for connection with a chassis of a mobile robot;
a coupling device disposed on the base, the coupling device movable between (i) an engaged position to engage the coupling device with a track of a target object and constrain motion of the coupling device along a length of the track, and (ii) a disengaged position to permit motion of the coupling device along the length of the track, and constrain motion of the coupling device orthogonal to the track; and
a communications interface to communicatively connect the coupling device with a processor and receive control instructions therefrom.

18. The docking accessory of claim 17, wherein the coupling device includes a claw movable between (i) the engaged position to grasp a rail extending from the target object to define the track, and (ii) the disengaged position to release the rail.

19. The docking accessory of claim 17, wherein the coupling device includes a plunger movable between (i) the engaged position to frictionally engage with a channel of the target object defining the track, and (ii) the disengaged position to retract from the channel.

20. The docking accessory of claim 17, further comprising:
a locking pin extendable from the coupling device in the engaged position.
